(19) United States
(12) Patent Application Publication
(10) Pub. No.: US 2024/0193608 A1
(43) Pub. Date: Jun. 13, 2024

(54) COMPUTERIZED-METHOD AND COMPUTERIZED-SYSTEM FOR IDENTIFYING FRAUD TRANSACTIONS IN TRANSACTIONS CLASSIFIED AS LEGIT TRANSACTIONS BY A CLASSIFICATION MACHINE LEARNING MODEL

(71) Applicant: Actimize LTD., Ra'anana (IL)

(72) Inventors: Sunny THOLAR, Pune (IN); Harshit JUNEJA, Shamli (IN); Pravin DAHIPHALE, Pune (IN)

(21) Appl. No.: 18/079,910

(22) Filed: Dec. 13, 2022

(51) Int. Cl. G06Q 20/40; G06N 20/00

(52) U.S. Cl. CPC G06Q 20/4016; G06N 20/00

(57) ABSTRACT

A computerized-method for identifying fraud transactions in transactions classified as legit transactions by a classification Machine Learning (ML) model, in a financial system, is provided herein. The computerized-method includes operating training by: (i) retrieving a dataset of fraud-labeled transactions to train a ML fraud model on the dataset of fraud-labeled transactions, to mark transactions as ‘similar’ or ‘novel’; and (ii) retrieving a dataset of legit-labeled transactions to train a ML legit model on the dataset of legit-labeled transactions, to mark transactions as ‘similar’ or ‘novel’; and deploying a classification ML model, a trained ML fraud model and a trained ML legit model in a computerized environment to identify fraud transactions in transactions which have been classified as legit transactions by the classification ML model. The trained classification ML model has been trained on a dataset of preconfigured transactions from the data store, to mark transactions as ‘legit’ or ‘fraud’.

### TECHNICAL FIELD

The present disclosure relates to the field of Machine Learning (ML) models within financial crime.

### BACKGROUND

Machine Learning (ML) models learn to classify financial transactions into fraud or legit, during training phase, based on patterns which have been identified in historical data. For example, fraud detection ML models are trained over 5-6 months of the historical data. There may be fraud patterns which the classification ML model can't learn during training. Major reasons for this are the scarcity of fraud instances which makes it hard for the classification ML model to accurately learn, or when a fraud pattern is new in the system and the classification ML model has never processed it or when fraud has occurred a long time before the time duration of the historical data that has been retrieved for training. Hence, such fraud transactions would be missed and marked as legit by the classification ML model.

Accordingly, there is a need for a system and method for identifying fraud transactions in transactions classified as legit transactions by a classification Machine Learning (ML) model.

### SUMMARY

There is thus provided, in accordance with some embodiments of the present disclosure, a computerized-method for identifying fraud transactions in transactions classified as legit transactions by a classification Machine Learning (ML) model, in a financial system.

In accordance with some embodiments of the present disclosure, in a system comprising one or more processors, data store of transactions which are fraud-labeled transactions and legit-labeled transactions.

Furthermore, in accordance with some embodiments of the present disclosure, the one or more processors may be configured to operate training.

Furthermore, in accordance with some embodiments of the present disclosure, the one or more processors may be configured to operate training by retrieving from the data store a dataset of fraud-labeled transactions to train a ML fraud model on the dataset of fraud-labeled transactions, to mark transactions as ‘similar’ or ‘novel’; and then retrieving from the data store a dataset of legit-labeled transactions to train a ML legit model on the dataset of legit-labeled transactions, to mark transactions as ‘similar’ or ‘novel’.

Furthermore, in accordance with some embodiments of the present disclosure, the one or more processors may be further configured to deploy a classification ML model, trained ML fraud model and trained ML legit model in a computerized environment to identify fraud transactions in transactions which have been classified as legit transactions by the classification ML mode.

Furthermore, in accordance with some embodiments of the present disclosure, the trained classification ML model has been trained on a dataset of preconfigured transactions from the data store, to mark transactions as ‘legit’ or ‘fraud.’

Furthermore, in accordance with some embodiments of the present disclosure, transactions classified as ‘legit’ transactions by the classification ML model may be sent to a trained ML legit model to be processed and marked as ‘similar’ or as ‘novel’ and transactions marked as ‘novel’ by the trained ML legit model, may be sent to a trained ML fraud model to be processed and marked as ‘similar’ or as ‘novel’. Then, transactions marked as ‘novel’ by the ML fraud model may be identified as potential unknown fraud transactions and transactions marked as ‘similar’ by the ML fraud model may be identified as potential missed fraud.

Furthermore, in accordance with some embodiments of the present disclosure, the computerized-method may be further comprising calculating a novelty-score for transactions that have been marked as ‘novel’ by the ML fraud model, and a preconfigured number of transactions having highest novelty-score may be transmitted to a user for investigation.

Furthermore, in accordance with some embodiments of the present disclosure, the computerized-method may be further comprising calculating a similarity-score for transactions that have been marked as ‘similar’ by the ML fraud model, and a preconfigured number of transactions having highest similarity-score may be transmitted to a user for investigation.

Furthermore, in accordance with some embodiments of the present disclosure, the computerized environment may be at least one of: test environment, production environment or staging environment.

Furthermore, in accordance with some embodiments of the present disclosure, the legit model and the fraud model may be trained by an unsupervised algorithm that learns a decision function for classifying transactions as either similar or different to the provided dataset.

Furthermore, in accordance with some embodiments of the present disclosure, the retrieved fraud-labeled transactions may be transactions from a preconfigured time.

Furthermore, in accordance with some embodiments of the present disclosure, the retrieved legit-labeled transactions may be a sample that has been retrieved randomly from the legit-labeled transactions in the data store.

Furthermore, in accordance with some embodiments of the present disclosure, the marking of transactions as ‘similar’ may indicate that a pattern of the transactions is similar to transactions provided during training and transactions marked as ‘novel’ may indicate that the pattern of the transactions is not similar to transactions provided during the training.

Furthermore, in accordance with some embodiments of the present disclosure, the unsupervised algorithm may be a one-class Support Vector Machine (SVM) that uses a hypersphere to encompass all transactions.

### BRIEF DESCRIPTION OF THE DRAWINGS

In order for the present invention, to be better understood and for its practical applications to be appreciated, the following Figures are provided and referenced hereafter. It should be noted that the Figures are given as examples only and in no way limit the scope of the invention. Like components are denoted by like reference numerals.

FIG. 1 schematically illustrates a high-level diagram of a computerized-system for generating a classification model for identifying fraud transactions in transactions classified as legit transactions by a classification Machine Learning (ML) model, in a financial system, in accordance with some embodiments of the present invention;

FIG. 2 is a schematic flowchart of an operation of identifying fraud transactions in transactions classified as legit transactions by a classification Machine Learning (ML) model, in a financial system, in accordance with some embodiments of the present invention;

FIG. 3 shows an example of financial tabular data, in accordance with some embodiments of the present invention;

FIG. 4 shows a scenario of identification of transactions classified as legit transactions by a classification Machine Learning (ML) model, in a financial system, in accordance with some embodiments of the present invention;

FIG. 5 is a schematic flowchart of ML model training, in accordance with some embodiments of the present invention;

FIG. 6 shows results from XGB model, in accordance with some embodiments of the present invention;

FIG. 7 is a high-level process flow diagram of a Fraud Management System, in accordance with some embodiments of the present disclosure, in accordance with some embodiments of the present invention; and

FIG. 8 shows an example of a hypersphere to encompass all of the instances, in accordance with some embodiments of the present invention.

### DETAILED DESCRIPTION

In the following detailed description, numerous specific details are set forth in order to provide a thorough understanding of the disclosure. However, it will be understood by those of ordinary skill in the art that the disclosure may be practiced without these specific details. In other instances, well-known methods, procedures, components, modules, units and/or circuits have not been described in detail so as not to obscure the disclosure.

Although embodiments of the disclosure are not limited in this regard, discussions utilizing terms such as, for example, “processing,” “computing,” “calculating,” “determining,” “establishing”, “analyzing”, “checking”, or the like, may refer to operation(s) and/or process(es) of a computer, a computing platform, a computing system, or other electronic computing device, that manipulates and/or transforms data represented as physical (e.g., electronic) quantities within the computer's registers and/or memories into other data similarly represented as physical quantities within the computer's registers and/or memories or other information non-transitory storage medium (e.g., a memory) that may store instructions to perform operations and/or processes.

Although embodiments of the disclosure are not limited in this regard, the terms “plurality” and “a plurality” as used herein may include, for example, “multiple” or “two or more”. The terms “plurality” or “a plurality” may be used throughout the specification to describe two or more components, devices, elements, units, parameters, or the like. Unless explicitly stated, the method embodiments described herein are not constrained to a particular order or sequence. Additionally, some of the described method embodiments or elements thereof can occur or be performed simultaneously, at the same point in time, or concurrently. Unless otherwise indicated, use of the conjunction “or” as used herein is to be understood as inclusive (any or all of the stated options).

Due to operational capacity of financial institutions, a threshold may be determined for a risk score that is calculated for each transaction, which indicates a possibility that a transaction is fraudulent. Only transactions having a risk score above the determined threshold may be forwarded for evaluation, since it is not feasible to alert as to every fraudulent transaction, due to capacity limitations of the financial institution.

However, the determined threshold due to operational capacity may leave transactions having a risk score below the determined threshold unattended or not inspected. Therefore, there is a need for a system and method for identifying fraud transactions in transactions that have been classified as legit transactions by a classification Machine Learning (ML) model, in a financial system.

The term ‘transaction’ as used herein, refers to a set of features or attributes which are associated to the transaction.

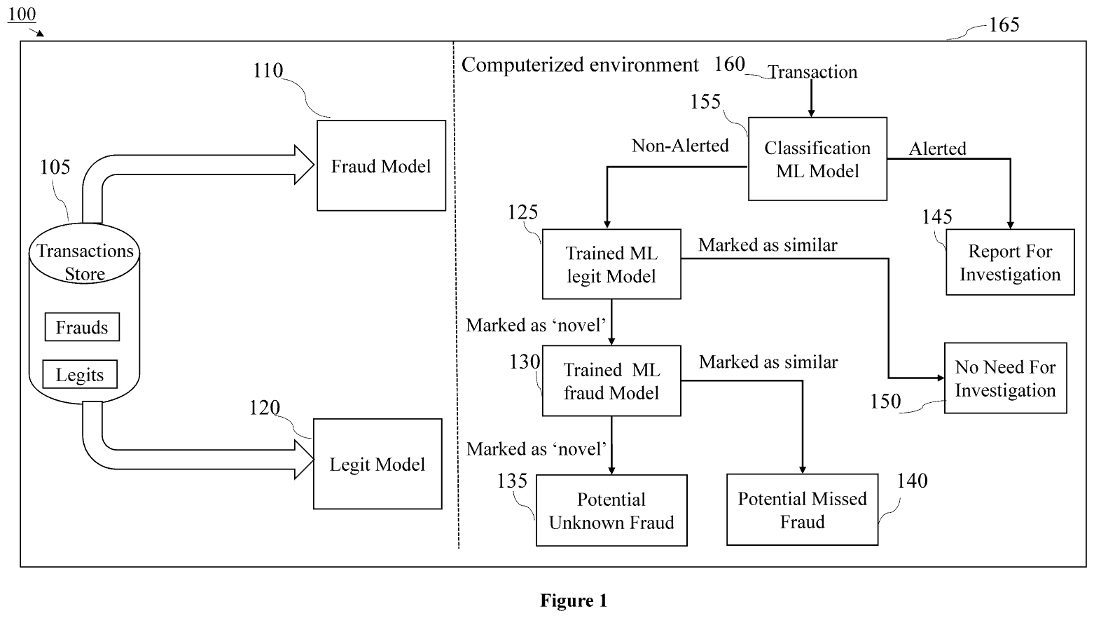

FIG. 1 schematically illustrates a high-level diagram of a computerized-system 100 for generating a classification model for identifying fraud transactions in transactions classified as legit transactions by a classification Machine Learning (ML) model, in a financial system, in accordance with some embodiments of the present invention.

According to some embodiments of the present disclosure, a system, such as system 100 may overcome a limitation of a threshold that has been set due to operational capacity by separately training two ML models to identify fraud transactions in transactions which have been classified as legit transactions by a classification ML model, such as classification ML model 155.

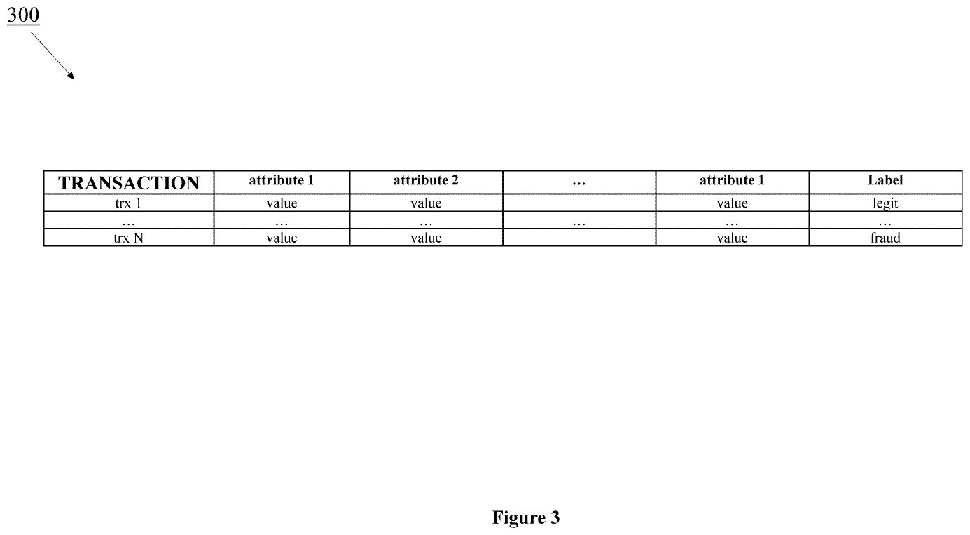

According to some embodiments of the present disclosure, in a system, such as system 100, two unsupervised ML models may be trained. The training may be operated by retrieving from a data store, such as transactions data store 105, a dataset of fraud-labeled transactions to train a ML fraud model 110 on the dataset of fraud-labeled transactions. The training of the ML fraud model 110 is to mark transactions as ‘similar’ or ‘novel’. Then, retrieving from the data store a dataset of legit-labeled transactions to train a ML legit model on the dataset of legit-labeled transactions. The training of the ML legit model is to mark transactions as ‘similar’ or ‘novel’. The dataset may be for example such as financial tabular data 300 in FIG. 3.

According to some embodiments of the present disclosure, a first trained ML model, such as trained ML legit model 125, may filter high potential fraudulent transactions out of a large number of transactions, e.g., million transactions and a second ML model, such as trained ML fraud model 130 may rank these high potential fraudulent transactions or classify it as ‘novel’ which indicates it is a potential unknown fraud or as ‘similar’ which indicates of potential missed fraud.

According to some embodiments of the present disclosure, the trained ML legit model 125 may mark as ‘similar’, ‘legit’ transaction.

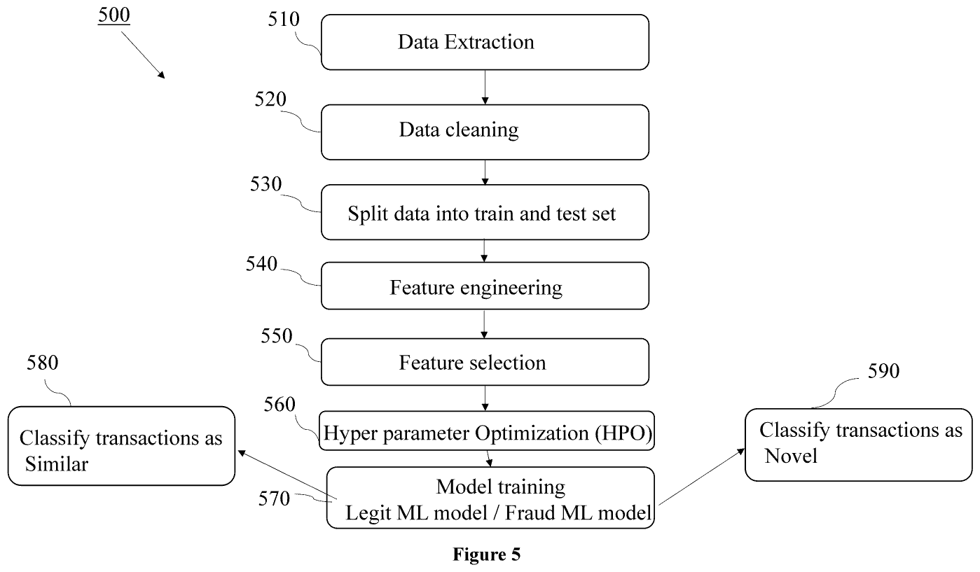

According to some embodiments of the present disclosure, the determination of each model, e.g., trained ML legit model 125 and trained ML fraud model 130 of similar or novel transactions is based on estimation of the density of probability for the data, e.g., the selected features, as shown in 550 in FIG. 5. Novelty corresponds to samples, i.e., transactions, where the density of probability, i.e., distance is very low. The determination of low distance depends on the configuration. Based on the number of features, each model may create N dimensional space and may assign the transactional points in this space. Eventually, based on how far a point which represents a transaction from a dense region, each model may determine whether the point is novel or similar.

According to some embodiments of the present disclosure, the operation of system 100 may use two unsupervised ML models, such as trained ML legit model 125 and trained ML fraud model 130 along with an existing classification ML model 155 to prioritize transactions having a risk score below a determined threshold and which may be fraudulent transactions.

According to some embodiments of the present disclosure, system 100 may identify fraud transactions in transactions classified as legit transactions by a classification Machine Learning (ML) model, in a financial system.

According to some embodiments of the present disclosure, in a system that includes one or more processors and a data store of transactions, such as transactions store 105, having fraud-labeled transactions and legit-labeled transactions, the one or more processors may be configured to operate training of a model, such as ML fraud model 110 and ML legit model 120 and then after the training, a classification ML model, trained ML fraud model and trained ML legit model may be deployed in a computerized environment 165 to identify fraud transactions in transactions which have been classified as legit transactions by a model, such as a classification ML model 155. The computerized environment may be at least one of: test environment, production environment or staging environment.

According to some embodiments of the present disclosure, a transaction 160 may be classified as legit transaction by the classification ML model 155. The transaction may be forwarded to a trained ML legit model 125 to be marked as ‘novel’ or ‘similar’. For transactions that have been marked as ‘similar’ by the trained ML legit model 125 there is no need for further investigation 150.

According to some embodiments of the present disclosure, transactions that have been marked as ‘novel’ by the trained ML legit model 125 may be forwarded to the trained ML fraud model 130. The trained ML fraud model 130 may mark the forwarded transactions as ‘similar’ which may indicate that it is potential missed fraud 140 or as novel, which may indicate that it is potential unknown fraud 135.

According to some embodiments of the present disclosure, the classification ML model 155 may be an existing ML model which has been previously trained.

According to some embodiments of the present disclosure, the training may include retrieving from the data store, such as transactions store 105, a dataset of fraud-labeled transactions to train a model, such as fraud model 110, on the dataset of fraud-labeled transactions, to mark transactions as ‘similar’ or ‘novel’, and then retrieving from the data store a dataset of legit-labeled transactions to train a legit model 120 on the dataset of legit-labeled transactions, to mark transactions as ‘similar’ or ‘novel’.

According to some embodiments of the present disclosure, the retrieved fraud-labeled transactions are transactions from a preconfigured time and the retrieved legit-labeled transactions may be a sample retrieved randomly from the legit-labeled transactions in the data store, such as transactions store 105.

According to some embodiments of the present disclosure, the training of the fraud model 110 to mark transactions as ‘similar’ or ‘novel’ may be operated by an unsupervised algorithm which learns a decision function for classifying new data as either ‘similar’ or ‘novel’ to the dataset of fraud-labeled transactions.

According to some embodiments of the present disclosure, the training of the legit model 120 to mark transactions as ‘similar’ or ‘novel’ may be operated by an unsupervised algorithm which learns a decision function for classifying new data, e.g., transactions, as either ‘similar’ or ‘novel’ to the dataset of legit-labeled transactions.

According to some embodiments of the present disclosure, in a non-limiting example, one-class Support Vector Machine (SVM) may be the unsupervised algorithm that learns the decision function for novelty detection, i.e., classifying new data as ‘similar’ or ‘novel’ to the training dataset. One-class SVM uses a hypersphere to encompass all of the instances.

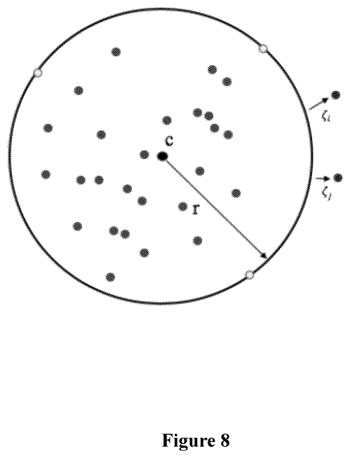

According to some embodiments of the present disclosure, the detection of novelty by the one-class SVM is done by separating the data points inside and outside of the hypersphere, as shown in FIG. 8. This approach results in functions that focus on the space where the density is maximum so that function can retire +1, when a point, e.g., transaction resides within a dense region, which indicates that the point is similar, compared to transactions provided in the dataset in the training phase, if the observation is in a dense region and −1, when a point, e.g., transaction resides within a sparse region which indicates that a point, e.g., transaction is new or novel compared to transactions provided in the dataset in the training phase, if the observation belongs to the low dense space.

According to some embodiments of the present disclosure, after the classification ML model 155, trained ML fraud model 130 and trained ML legit model 125 have been deployed in a computerized environment to identify fraud transactions in transactions which have been classified as legit transactions by a model, such as a classification ML model 155, transactions which have been classified as ‘legit’ transactions by the classification ML model 155 are sent to a trained ML legit model 125 to be processed and marked as ‘similar’ or as ‘novel’.

According to some embodiments of the present disclosure, transactions marked as ‘novel’ by the trained ML legit model 125, may be sent to a trained ML fraud model 130 to be processed and marked as ‘similar’ or as ‘novel’, and transactions marked as ‘novel’ by the trained ML fraud model 130 are identified as potential unknown fraud transactions and transactions marked as ‘similar’ by the trained ML fraud model 130 are identified as potential missed fraud.

According to some embodiments of the present disclosure, a novelty-score may be calculated for transactions that have been marked as ‘novel’ by the trained ML fraud model 130, and a preconfigured number of transactions having highest novelty-score may be transmitted to a user for investigation.

According to some embodiments of the present disclosure, a similarity-score may be calculated for transactions that have been marked as ‘similar’ by the trained ML fraud model 130, and a preconfigured number of transactions having highest similarity-score may be transmitted to a user for investigation.

According to some embodiments of the present disclosure, marking transactions as ‘similar’ indicates that a pattern of these transactions is similar to transactions provided during training and transactions marked as ‘novel’ indicates that the pattern of these transactions is not similar to transactions provided during the training and may relate to a new pattern of fraud.

According to some embodiments of the present disclosure, optionally, the preconfigured number of transactions having highest similarity-score may be cancelled and the related account may be blocked. In another option the preconfigured number of transactions having highest similarity-score may trigger a text message to a user to trigger a call to the user.

According to some embodiments of the present disclosure, optionally, the preconfigured number of transactions having highest novelty-score may be cancelled. In another option the preconfigured number of transactions having highest novelty-score may trigger a text message to a user to trigger a call to the user.

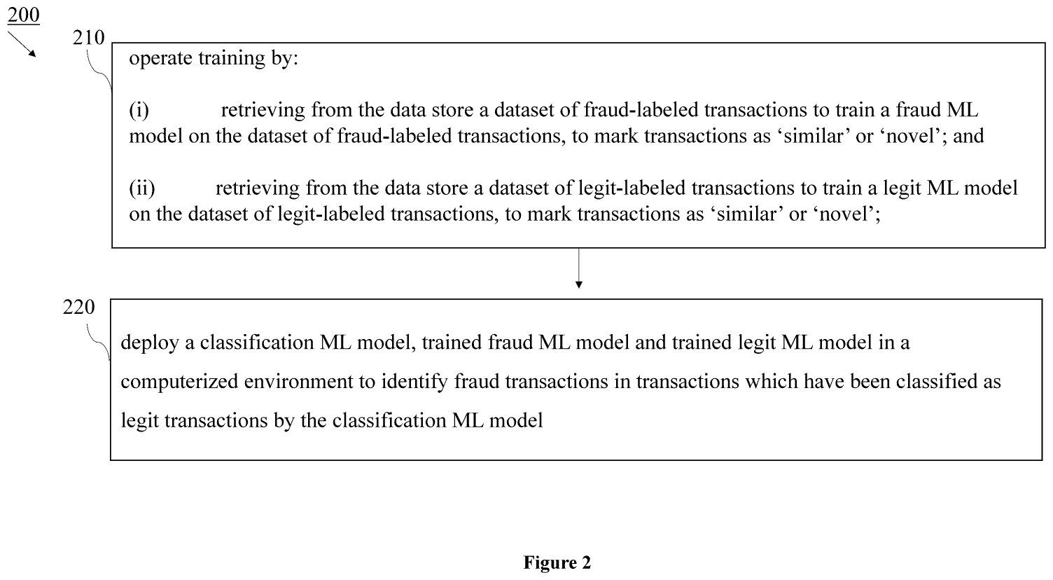

FIG. 2 is a schematic flowchart of an operation of identifying fraud transactions in transactions classified as legit transactions by a classification Machine Learning (ML) model, in a financial system, in accordance with some embodiments of the present invention.

According to some embodiments of the present disclosure, operation 210 comprising operate training by (i) retrieving from the data store a dataset of fraud-labeled transactions to train a fraud ML model on the dataset of fraud-labeled transactions, to mark transactions as ‘similar’ or ‘novel’; and (ii) retrieving from the data store a dataset of legit-labeled transactions to train a legit ML model on the dataset of legit-labeled transactions, to mark transactions as ‘similar’ or ‘novel’. According to some embodiments of the present disclosure, the fraud ML model may be a model, such as fraud model 110 in FIG. 1 and the legit ML model may be a model, such as legit model 120 in FIG. 1.

According to some embodiments of the present disclosure, operation 220 comprising deploy a classification ML model, trained fraud ML model and trained legit ML model in a computerized environment to identify fraud transactions in transactions which have been classified as legit transactions by the classification ML model.

According to some embodiments of the present disclosure, the classification ML model may be a model such as classification ML model 155 in FIG. 1, the trained fraud ML model may be a model, such as trained ML fraud model 130 and trained legit ML model may be a model, such as trained ML legit model 125 in FIG. 1, in a computerized environment, such as computerized environment 165 in FIG. 1.

FIG. 3 shows an example of financial tabular data 300, in accordance with some embodiments of the present invention.

According to some embodiments of the present disclosure, commonly a transaction includes various attributes that are heterogeneous by its nature: numerical, categorical, ordinal etc. Financial tabular data 300 shows different transactions with its attributes such as amount of transferred money, payer name, payor name, payer address, payor address, bank name, device type, geolocation and the like.

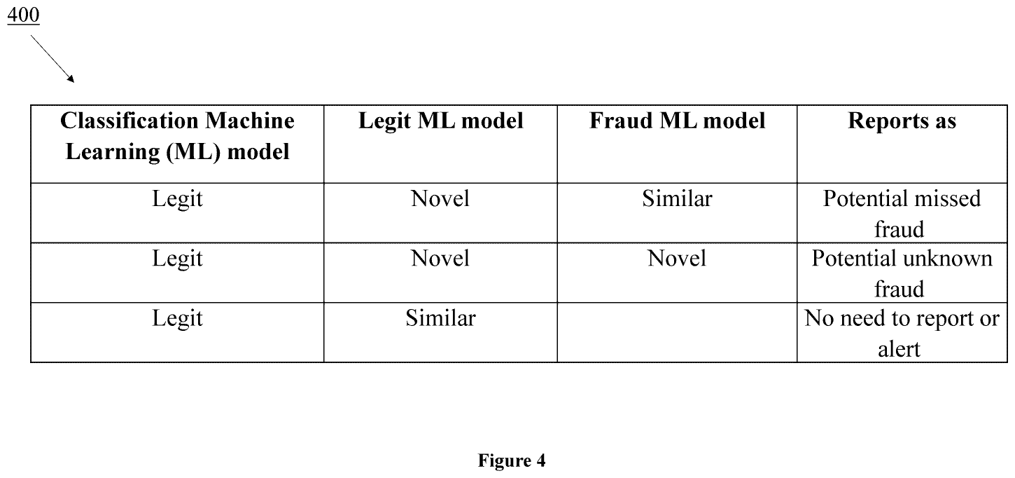

FIG. 4 shows a scenario 400 of identification of transactions classified as legit transactions by a classification Machine Learning (ML) model, in a financial system, in accordance with some embodiments of the present invention.

According to some embodiments of the present disclosure, all transactions which have been classified by a classification ML model, such as classification ML model 155 in FIG. 1, as legit transactions, would be processed through both legit ML model and fraud ML model, as shown in FIG. 1.

According to some embodiments of the present disclosure, a transaction that has been marked as legit by the classification ML model may be forwarded to a legit ML model, such as trained ML legit model 125 in FIG. 1. The legit ML model may nark it as ‘novel’ or as ‘similar’.

According to some embodiments of the present disclosure, when a transaction is marked as ‘novel’ the transaction may be forwarded to a fraud ML model to be marked as ‘similar’ or novel’. When the fraud ML model marks the transaction as ‘similar’ it may be reported as potential missed fraud and optionally may be blocked. When the transaction may be marked as ‘novel’ it may be reported as potential unknown fraud and optionally may be blocked.

According to some embodiments of the present disclosure, when a transaction is marked as ‘similar’ by the legit ML model, there is no need to report or alert. It may indicate that the transaction is not fraudulent transactions.

FIG. 5 is a schematic flowchart of ML model training 500, in accordance with some embodiments of the present invention.

According to some embodiments of the present disclosure, data extraction 510 may be operated by extracting data for 3-6 months from an Integrated Fraud Management (IFM) database for a specific base activity. Base activities are a way to logically group together events that occur in the client's systems for profiling and detection purposes. for example, Mobile Person to Person Transfer (M_P2P).

According to some embodiments of the present disclosure, the features that were considered for model inclusion consisted of all features available to the IFM decision process at the time of execution. This includes a variety of features describing the transaction and the party initiating the transaction. It also includes session information describing the connecting device and connection pathway, as well as the sequencing of the transaction in the current session. Filtered transaction was excluded from model development. Filters are a technical term used to represent business rules which help make processing of transaction in an effective manner. The purpose of the filter rule is to evaluate an incoming transaction and determine if the transaction needs to be further evaluated by a Machine Learning (ML) model. For Novelty legit model all the legit transactions may be used and for novelty fraud model only fraud transactions may be used.

According to some embodiments of the present disclosure, data cleaning 520 refers to identifying and correcting errors in the dataset that may negatively impact a predictive model. It includes removing features that will not add any value to the model. Cleaning the data includes removing null columns, correlated columns, duplicate rows and filling missing values. Features that are uniformly missing, and zero-variance features, i.e., features that are uniformly stuck at a single value, do not add any value and are removed. Highly correlated features are removed by calculating Pearson correlation coefficients between the pairs of transformed features and determining which features to eliminate.

According to some embodiments of the present disclosure, dataset is sub-setting part of the population that represents the different entities. Split data into training set and test set 530, due to the sparsity of the fraud transactions, all the fraudulent observations are kept while sampling only from legits. In a dataset, training set is used to build up a model, while a test set is to validate the model built. Data points in the training set are excluded from test set. Usually, a sampled dataset is divided into a training set and test set. In Machine Learning (ML) paradigm, a model is created to predict the test data, e.g., test set. The training data, e.g., training set, is used to fit the model and testing data to test it. The models generated are to predict results unknown which is named as the test set. The dataset is divided into train and test set in order to check accuracies, precisions by training and testing it on it. The data is split into 80% (train set) and 20% (test set), where the train has to be chronologically before the test to avoid data leakage. This is the approach used to create train and test samples in the financial domain.

According to some embodiments of the present disclosure, feature engineering 540 is the process of using domain knowledge to extract features from raw data. New features are created from the flat data, for example, date features are transformed into month, day and hour features and features based on business logic, such as the first and last digits of each transaction amount are added. Categorical features are encoded into frequency-based features based on below types of encoding, (a) one-hot encoding, which reduces each categorical value to a separate Boolean variable, based on whether the variable contains that value or not (b) lift-based encoding, where each category is assigned, a numeric value based on its relative propensity to identify fraud; and (c) population-based encoding, where each category is assigned, a numeric value based on its relative frequency in the underlying population. It is important not to end up creating too many features. As a result, the number of engineered features is kept low, to avoid the curse of dimensionality.

According to some embodiments of the present disclosure, operating feature selection 550 improves the machine learning process and increases the predictive power of machine learning algorithms by selecting the most important variables and eliminating redundant and irrelevant features. After feature engineering is performed, feature score is generated by using machine learning technique to identify relevant features to be used in the model training.

According to some embodiments of the present disclosure, hyper parameter optimization 510 or tuning in machine learning paradigm is the problem of choosing a set of optimal hyperparameters for a learning algorithm. A hyperparameter is a parameter whose value is used to control the learning process. Hyperparameter optimization finds a tuple of hyperparameters that yields an optimal model which minimizes a predefined loss function on given independent data. The objective function takes a tuple of hyperparameters and returns the associated loss. The traditional way of performing hyperparameter optimization has been grid search, or a parameter sweep, which is an exhaustive searching through a manually specified subset of the hyperparameter space of a learning algorithm. A grid search algorithm must be guided by some performance metric, typically measured by cross-validation on the training set or evaluation on a hold-out validation set. Since the parameter space of a machine learner may include real-valued or unbounded value spaces for certain parameters, manually set bounds and discretization may be necessary before applying grid search.

According to some embodiments of the present disclosure, to ensure that the model is capturing the novelties in a correct manner, a small proportion of novel class, e.g., for a ML legit model fraud transactions and for the ML fraud model legit transactions may be added to each model and that proportion is same as ‘nu’ hyperparameter. Grid search then trains a One Class SVM with each pair in the Cartesian product and evaluates their performance by internal cross-validation on the training set, in which case multiple SVMs are trained per pair. Finally, the grid search algorithm outputs the settings that achieved the highest score in the validation procedure.

According to some embodiments of the present disclosure, model training of legit ML model and fraud ML model 570 may be based on novelty detection, which means the identification of new or unknown data that a machine learning system is not aware of during training. Novelty detection methods try to identify observations that differ from the distribution of ordinary data which has been countered during training. Two models are created, as fraud model 110 in FIG. 1 and legit model 120 in FIG. 1. For the legit model, novelty means training only on legit transactions and thus legit transactions are ordinary and whichever observations are not a close match to the legit transactions, will be marked as novel. It is expected that the fraud observations will be different from ordinary data that has been provided during training and thus shall be marked as novel by this model, e.g., classify transaction as novel 590.

According to some embodiments of the present disclosure, for the fraud model, novelty means training only on fraud transactions and thus fraud transactions are ordinary and whichever observations are not a close match to fraud transactions, will be marked as similar 580. It is expected that the legit observations will be quite different from ordinary data and thus shall be marked as novel by this model.

According to some embodiments of the present disclosure, One-class SVM is an unsupervised algorithm that learns a decision function for novelty detection: classifying new data as similar or different, e.g., novel, to the training set. One-Class SVM uses a hypersphere to encompass all of the instances, as shown in FIG. 8. The detection of novelty is performed by separating the data points i.e., transactions, inside and outside of the hypersphere. This approach results in functions that focus on the space where the density is maximum so that function can retire +1 if the observation is in a dense region, i.e., similar and −1 if the observation belongs to the low dense space, i.e., novel.

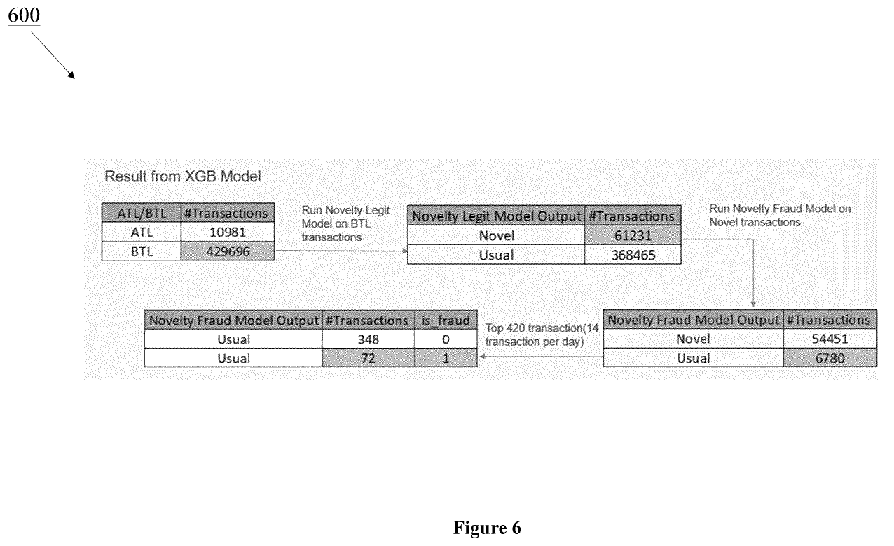

FIG. 6 shows results from XGB model 600, in accordance with some embodiments of the present invention.

According to some embodiments of the present disclosure, results from XGB model 600 shows 10,981 transactions Above The Line (ATL) transactions and 429,696 transactions Below The Line (BTL) transactions from existing classification model, e.g., classification ML model 155 in FIG. 1. ATL are the transactions which are alerted by an existing classification ML model, such as classification ML model 155 in FIG. 1, e.g., XGB model and BTL transactions are the transactions which are not alerted by existing model.

According to some embodiments of the present disclosure, in the table 600 of results from XGB model, which are from Proof of Concept (POC) performed of a system such as system 100 in FIG. 1 or operation 200 of identifying fraud transactions in transactions classified as legit transactions by a classification Machine Learning (ML) model, in a financial system in FIG. 2, by looking into top 420 transactions from BTL transactions, 72 more fraud transactions have been identified which were hidden and are currently marked by the existing classification ML model, as legit.

According to some embodiments of the present disclosure, the 429,696 transaction which are marked as legit So this transaction may be forwarded to a ML legit model, such as trained ML legit model 125 in FIG. 1, which has marked 61,231 as ‘novel’, i.e., fraud or not legit. Then, the 61,231 transactions may be forwarded to a ML fraud model, such as trained ML fraud model 130 in FIG. 1, which marked 6,780 transactions as ‘similar’ which means that the pattern is similar to fraud.

According to some embodiments of the present disclosure, as part of POC, based on score when looking at top 420 transactions 72 fraud transactions may be identified which consequently were marked as legit by an existing classification model, e.g., classification ML model 155 in FIG. 1. The 420 number is configurable and may depend on the capacity of the client.

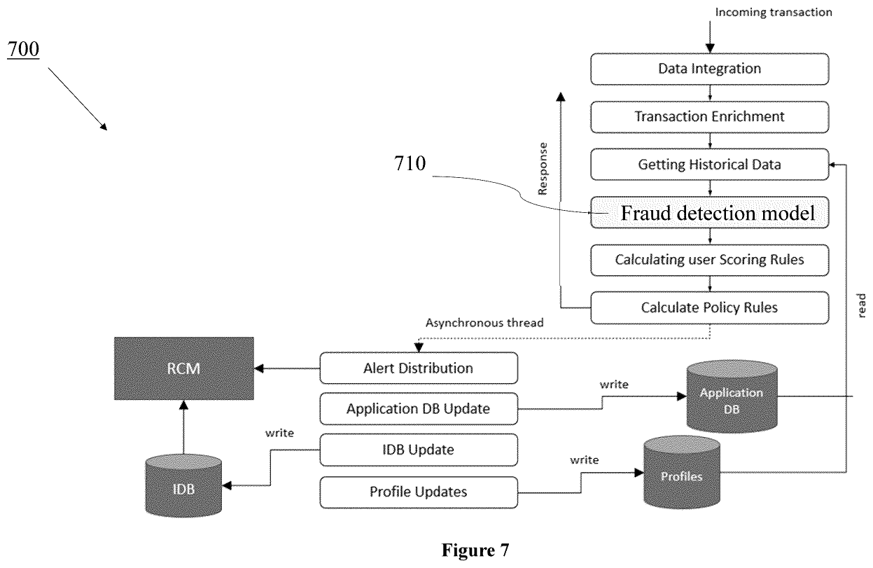

FIG. 7 is a high-level process flow diagram of a Fraud Management System, in accordance with some embodiments of the present disclosure, in accordance with some embodiments of the present invention.

According to some embodiments of the present disclosure, in a system, such as Fraud Management System 700 and such as Integrated Fraud Management (IFM) system 700 in FIG. 7, there are incoming transactions into a data integration component which operates an initial preprocess of the data. Transaction enrichments component operates a preprocess of the transactions. The process of getting historical data synchronizes with new incoming transactions is followed by a fraud detection model 710 after which, each transaction gets its risk score. User scoring rules? Policy calculation rules handles the suspicious risk scores and routes them accordingly.

Profiles database contains aggregated financial transactions according to a time period. Profile updates synchronize according to newly opened accounts or incoming transactions. Risk Case Management (RCM) system is a system that operates a risk score management, including investigation, monitoring, sending alerts, or marking as no risk.

An Investigation DataBase (IDB) system is operating to research transactional data and policy rules resulting for investigation purposes. It analyzes historical cases and alert data. Data can be used by the solution or by external applications that can query the database, for example, to produce rule performance reports.

According to some embodiments of the present disclosure, analysts can define calculated variables using a comprehensive context, such as the current transaction, the history of the main entity associated with the transaction, the built-in models result etc. These variables can be used to create new indicative features. The variables can be exported to the detection log, stored in IDB and exposed to users in user analytics contexts.

According to some embodiments of the present disclosure, transactions that satisfy certain criteria may indicate occurrence of events that may be interesting for the analyst. The analyst can define events the system identifies and profiles when processing the transaction. This data can be used to create complementary indicative features (using the custom indicative features mechanism or SMO). For example, the analyst can define an event that says: amount >$100,000. The system profiles aggregations for all transactions that trigger this event e.g., first time it happened for the transaction party etc.

According to some embodiments of the present disclosure, once custom events are defined, the analyst can use predefined indicative feature templates to enrich built-in models results with new indicative features calculations. The analyst may create an indicative feature that says that if it has been more than a year since the customer performed a transaction with amount greater than $100,000 then add 10 points to the overall risk score of the model.

FIG. 8 shows an example of a hypersphere to encompass all of the instances, in accordance with some embodiments of the present invention.

According to some embodiments of the present disclosure, one-class Support Vector Machine (SVM) is an unsupervised algorithm that learns a decision function for novelty detection: classifying new data as similar or different to the training set. One-Class SVM uses a hypersphere to encompass all of the instances.

It should be understood with respect to any flowchart referenced herein that the division of the illustrated method into discrete operations represented by blocks of the flowchart has been selected for convenience and clarity only. Alternative division of the illustrated method into discrete operations is possible with equivalent results. Such alternative division of the illustrated method into discrete operations should be understood as representing other embodiments of the illustrated method.

Similarly, it should be understood that, unless indicated otherwise, the illustrated order of execution of the operations represented by blocks of any flowchart referenced herein has been selected for convenience and clarity only. Operations of the illustrated method may be executed in an alternative order, or concurrently, with equivalent results. Such reordering of operations of the illustrated method should be understood as representing other embodiments of the illustrated method.

Different embodiments are disclosed herein. Features of certain embodiments may be combined with features of other embodiments; thus, certain embodiments may be combinations of features of multiple embodiments. The foregoing description of the embodiments of the disclosure has been presented for the purposes of illustration and description. It is not intended to be exhaustive or to limit the disclosure to the precise form disclosed. It should be appreciated by persons skilled in the art that many modifications, variations, substitutions, changes, and equivalents are possible in light of the above teaching. It is, therefore, to be understood that the appended claims are intended to cover all such modifications and changes as fall within the true spirit of the disclosure.

While certain features of the disclosure have been illustrated and described herein, many modifications, substitutions, changes, and equivalents will now occur to those of ordinary skill in the art. It is, therefore, to be understood that the appended claims are intended to cover all such modifications and changes as fall within the true spirit of the disclosure.

What is claimed:

1. Computerized-method for identifying fraud transactions in transactions classified as legit transactions by a classification Machine Learning (ML) model, in a financial system, the computerized-method comprising:
in a system comprising one or more processors and a data store of transactions which are fraud-labeled transactions and legit-labeled transactions, said one or more processors is configured to:
operate training by:
(i) retrieving from the data store a dataset of fraud-labeled transactions to train a ML fraud model on the dataset of fraud-labeled transactions, to mark transactions as ‘similar’ or ‘novel’; and
(ii) retrieving from the data store a dataset of legit-labeled transactions to train a ML legit model on the dataset of legit-labeled transactions, to mark transactions as ‘similar’ or ‘novel’;
deploy a classification ML model, a trained ML fraud model and a trained ML legit model in a computerized environment to identify fraud transactions in transactions which have been classified as legit transactions by the classification ML model,
wherein the trained classification ML model has been trained on a dataset of preconfigured transactions from the data store, to mark transactions as ‘legit’ or ‘fraud’.

2. The computerized-method of claim 1, wherein transactions classified as ‘legit’ transactions by the classification ML model are sent to a trained ML legit model to be processed and marked as ‘similar’ or as ‘novel’,
wherein transactions marked as ‘novel’ by the trained ML legit model, are sent to a trained ML fraud model to be processed and marked as ‘similar’ or as ‘novel’, and
wherein transactions marked as ‘novel’ by the trained ML fraud model are identified as potential unknown fraud transactions and transactions marked as ‘similar’ by the trained ML fraud model are identified as potential missed fraud.

3. The computerized-method of claim 2, wherein the computerized-method further comprising calculating a novelty-score for transactions that have been marked as ‘novel’ by the ML fraud model, and wherein a preconfigured number of transactions having highest novelty-score are transmitted to a user for investigation.

4. The computerized-method of claim 2, wherein the computerized-method further comprising calculating a similarity-score for transactions that have been marked as ‘similar’ by the ML fraud model, and wherein a preconfigured number of transactions having highest similarity-score are transmitted to a user for investigation.

5. The computerized-method of claim 1, wherein the computerized environment is at least one of: test environment, production environment or staging environment.

6. The computerized-method of claim 1, wherein the legit model and the fraud model are trained by an unsupervised algorithm that learns a decision function for classifying transactions as either similar or different to the provided dataset.

7. The computerized-method of claim 1, wherein the retrieved fraud-labeled transactions are transactions from a preconfigured time.

8. The computerized-method of claim 1, wherein the retrieved legit-labeled transactions are a sample retrieved randomly from the legit-labeled transactions in the data store.

9. The computerized-method of claim 1, wherein marking transactions as ‘similar’ indicates that a pattern of the transactions is similar to transactions provided during training and wherein transactions marked as ‘novel’ indicates that the pattern of the transactions is not similar to transactions provided during the training.

10. The computerized-method of claim 1, wherein the unsupervised algorithm is a one-class Support Vector Machine (SVM) that uses a hypersphere to encompass all transactions.
